(19) United States
(12) Patent Application Publication
(10) Pub. No.: US 2019/0161654 A1
(43) Pub. Date: May 30, 2019

(54) HOT MELT ADHESIVE WITH NON-HYDROGENATED HIGH SOFTENING POINT C5 TACKIFYING AGENT

(71) Applicant: H.B. Fuller Company, St. Paul, MN (US)

(72) Inventor: Mark S. Kroll, Arden Hills, MN (US)

(21) Appl. No.: 16/206,103

(22) Filed: Nov. 30, 2018

Related U.S. Application Data
(60) Provisional application No. 62/592,613, filed on Nov. 30, 2017.

(51) Int. Cl. C09J 123/14; C09J 5/06; C09J 123/12; C09J 11/06; B32B 5/02; B32B 7/12; B32B 27/32; B32B 27/12

(52) U.S. Cl. CPC C09J 123/14; C09J 5/06; C09J 123/12; C09J 11/06; B32B 5/022; B32B 2555/00; B32B 27/32; B32B 27/12; C09J 2423/10; B32B 2262/0253; B32B 2307/7265; B32B 7/12

(57) ABSTRACT

The invention includes a hot melt adhesive composition including a single-site catalyzed propylene-based polymer that has a co-monomer content of from 0% by weight to 20% by weight and a Brookfield Viscosity at 190° C. of no greater than 25,000; and a non-hydrogenated C5 tackifying agent having a softening point of from 98° C. to around 130° C. The adhesive composition has been found to give a good balance of static peel strength and dynamic peel strength when used as a construction adhesive in a disposable absorbent article.

### BACKGROUND

This application claims the benefit of U.S. Provisional application Ser. No. 62/592,613 filed Nov. 30, 2017, which is incorporated herein.

Adhesives are often used to bond substrates together so as to maintain the two substrates in a fixed relation to each other. In the area of industrial adhesives, hot melt adhesives are commonly used to bond together a wide variety of articles including disposable absorbent articles comprising non-woven substrates e.g. adult incontinence products, disposable diapers, sanitary napkins, bed pads, puppy pads, medical dressings, etc.

There can be multiple hot melt adhesives used in the manufacture of a disposable absorbent article. For example, in the manufacture of a disposable diaper, hot melt adhesives are used in construction (e.g. bonding the back sheet to the nonwoven and optionally the absorbent pad), elastic attachment (e.g. bonding the elastic material to the back sheet in for example the leg or waist area), and for core stabilization (e.g. applying an adhesive to the absorbent core to increase the strength of the core).

For construction applications it is important that the hot melt adhesive have both static peel strength (good cohesion i.e. internal strength) and dynamic peel strength (good adhesion to the substrates). When formulating with single-site catalyzed propylene-based polymers it has been a struggle to get both properties in one adhesive.

### SUMMARY

In one aspect, the invention features a hot melt adhesive composition including a single-site catalyzed propylene-based polymer that has a co-monomer content of from 0% by weight to 20% by weight and a Brookfield Viscosity at 190° C. of no greater than 25,000; and a non-hydrogenated high softening point C5 tackifying agent having a softening point of from 98° C. to around 130° C.

In one embodiment, the hot melt adhesive composition further includes from 5% to 35% by weight of a plasticizer. In a different embodiment, the hot melt adhesive composition further comprises a second tackifying agent. In another embodiment, the second tackifying agent is at least partially hydrogenated.

In some embodiments, the non-hydrogenated high softening point C5 tackifying agent is derived from at least 50% by weight C5 monomers. In other embodiments, the non-hydrogenated high softening point C5 tackifying agent is derived from at least 75% by weight C5 monomers. In another embodiment, the hot melt adhesive composition includes 15% by weight to 55% by weight of the non-hydrogenated high softening point C5 tackifying agent.

In one embodiment, hot melt adhesive composition includes from 15% by weight to 70% by weight of the single-site catalyzed propylene-based polymer. In a different embodiment, the non-hydrogenated high softening point C5 tackifying agent has a Molten Gardner Color (50% by weight in toluene) of no greater than 6.

In another embodiment, the single-site catalyzed propylene-based polymer comprises a single-site catalyzed propylene-based homopolymer and a single-site catalyzed propylene-based copolymer. In some embodiments, hot melt adhesive composition of further comprising a wax. In another embodiment, the plasticizer is a naphthenic oil includes at from 5% by weight to 20% by weight. In a different embodiment, the hot melt adhesive composition includes a naphthenic oil plasticizer and from 15% by weight to 55% by weight of the non-hydrogenated high softening point C5 tackifying agent.

In one embodiment the sum of the single-site catalyzed propylene based polymer, the non-hydrogenated high softening point C5 tackifying agent, the second tackifying agent and the plasticizer make up at least 90% by weight of the hot melt adhesive composition. In a different embodiment, the hot melt adhesive composition has a Brookfield Viscosity at 150° C. of no greater than 16,000 cP.

In a second aspect, the invention features a disposable absorbent article including a body fluid impermeable back sheet, a nonwoven top sheet, and a hot melt adhesive composition including a single-site catalyzed propylene-based polymer that has a co-monomer content of from 0% by weight to 20% by weight and a Brookfield Viscosity at 190° C. of no greater than 25,000; and a non-hydrogenated high softening point C5 tackifying agent having a softening point of from 98° C. to around 130° C. where the body fluid impermeable back sheet is adhered to the nonwoven top sheet through the hot melt adhesive composition.

In one embodiment, the hot melt adhesive composition used to make the disposable absorbent article includes from 15% by weight to 55% by weight of the non-hydrogenated high softening point C5 tackifying agent. In a different embodiment, the single-site catalyzed propylene-based polymer comprises a single-site catalyzed propylene-based homopolymer and a single-site catalyzed propylene-based copolymer.

Applicants have found that hot melt adhesive compositions including a single-site catalyzed propylene-based polymer and a non-hydrogenated high softening point C5 tackifying agent have improved static peel strength and maintain dynamic peel strength when used as a construction adhesive in a disposable absorbent article.

These hot melt adhesive compositions have further been found to offer a nice balance of low cost and performance.

### GLOSSARY

In reference to the invention, these terms have the meanings set forth below:

Propylene-based refers to a polymer that comprises at least 50% by weight propylene.

### DETAILED DESCRIPTION

Hot Melt Adhesive Composition

The hot melt adhesive composition can be a pressure sensitive adhesive. The hot melt adhesive composition can have an Initial Gardner Color after manufacturing of no greater than 5, no greater than 4, no greater than 3, or even from 1 to 5.

The hot melt adhesive composition includes a single-site catalyzed propylene-based polymer and a non-hydrogenated high softening point C5 tackifying agent having a softening point of from 98° C. to 130° C.

The single-site catalyzed propylene-based polymer, the non-hydrogenated high softening point C5 tackifying agent, the second tackifying agent and the plasticizer can make up at least 85% by weight of the composition, at least 90% by weight of the composition, at least 93% by weight of the composition, or even from 90% by weight to 100% by weight of the composition.

The viscosity of the hot melt adhesive composition can be no greater than 20,000 cP at 150° C., no greater than 16,000 cP at 150° C., no greater than 12,000 cP, no greater than 10,000 cP, from 2,000 cP to 20,000 cP, or even from 500 cP to 15,000 cP at 150° C.

The hot melt adhesive composition can have a Static Peel (@39° C.) (coat weight=6 gsm) of at least 18 minutes, at least 20 minutes, at least 23 minutes, from 18 minutes to 80 minutes, or even from 23 minutes to 80 minutes.

Single-Site Catalyzed Propylene-Based Polymer

The propylene-based polymer is a single-site (e.g. metallocene) catalyzed polymer.

The single-site catalyzed propylene-based polymer can have a Brookfield Viscosity at 190° C. of no greater than 25,000 cP, no greater than 20,000 cP, no greater than 15,000 cP, from 500 cP to 25,000 cP, from 2500 cP to 15,000 cP, or even from 3,000 cP to 12,000 cP.

Alternatively, the single-site catalyzed propylene-based polymer can have a melt index (190° C., 2.16 kg) when tested according to ASTM D1238 of no greater than 30, from 1 to 30, from 2 to 25, or even from 2 to 15.

The single-site catalyzed propylene-based polymer can be a blend of two of more single-site catalyzed propylene-based polymers. In one embodiment, the single-site catalyzed propylene-based polymer includes at least two single-site catalyzed propylene-based polymers, one having a Brookfield Viscosity at 190° C. of no greater than 25,000 cP and a second having a melt index (190° C., 2.16 kg), tested according to ASTM D1238 of from 1 to 30.

In another embodiment, the single-site catalyzed propylene-based polymer includes at least two single-site catalyzed propylene-based polymers, one having a Brookfield Viscosity at 190° C. of from 500 cP to 25,000 cP and a second having a melt index (190° C., 2.16 kg), tested according to ASTM D1238 of from 1 to 30.

In one embodiment, the propylene-based polymer has a limited amount of crystallinity. The propylene-based polymer can have a Heat of fusion (AH) as determined using differential scanning calorimetry according to ASTM E-793-06 entitled, “Standard Test Method for Enthalpies of Fusion and Crystallization by Differential Scanning calorimetry” of from 10 to 50 joules/gram, or even from 15 to 40 joules/gram.

The single-site catalyzed propylene-based polymer is present at from 15% by weight to 70% by weight, from 20% by weight to 60% by weight, from 25% by weight, to 55% by weight, from 25% by weight to 35% by weight, or even from 40% by weight to 70% by weight.

The single-site catalyzed propylene-based polymer can be copolymer or a homopolymer.

In a preferred embodiment, the single-site catalyzed propylene-based polymer can be a blend of a homopolymer and a copolymer.

The single-site catalyzed propylene-based copolymer can be derived from propylene and at least one alpha-olefin co-monomer other than propylene (e.g., C2, and C4-C20 alpha-olefin co-monomers, and combinations thereof). Useful alpha-olefin co-monomers include, e.g., alpha-olefin monomers having at least two carbon atoms, at least four carbon atoms, from four carbon atoms to eight carbon atoms, and combinations thereof. Examples of suitable classes of alpha-olefin co-monomers include mono-alpha olefins (i.e., one unsaturated double bond) and higher order alpha olefins (e.g., dienes (e.g., 1,9-decadiene)). Suitable alpha-olefin monomers include, e.g., ethylene, butene, pentene, hexene, heptene, octene, nonene, decene, dodecene, 4-methyl-pentene-1, 3-methyl pentene-1,3,5,5-trimethyl-hexene-1,5-ethyl-1-nonene, and combinations thereof. Specific examples of suitable propylene-alpha-olefin copolymers include propylene-ethylene, propylene-butene, propylene-hexene, propylene-octene, and combinations thereof.

The single site catalyzed propylene-based polymer can have a co-monomer content of from 0% to 30%, from 5% by weight to 20% by weight, from 6% by weight to 15% by weight, or even from 7% to 12% by weight.

Useful commercially available olefin polymers include e.g., VISTAMAXX 8880, VISTAMAXX 8380, VISTAMAXX 8780 and VISTAMAXX 6202, propylene ethylene copolymers from ExxonMobil Chemical Company (Houston, Tex.), LICOCENE 1602 and LICOCENE 2602, propylene ethylene copolymers from Clariant International Ltd. (Muttenz, Switzerland) and the LMODU series of trade designations from Idemitsu Kosan Co., Ltd. (Japan) including LMODU 5400 and LMODU 5410 propylene homopolymers.

Non-Hydrogenated High Softening Point C5 Tackifying Agent

The hot melt adhesive composition includes a non-hydrogenated high softening point C5 tackifying agent with a Ring and Ball Softening Point (ASTM E28) of from 98° C. to 130° C., or even from 98° C. to 120° C. A C5 tackifying agent is derived primarily from substantially linear aliphatic monomers having five carbons. The aliphatic monomers having five carbons can be branched or unbranched. Some common C5 monomers used to make C5 tackifying agents include dienes such as e.g. piperylene, 1,3-pentadiene, etc.

The non-hydrogenated high softening point C5 tackifying agent is derived from at least 50% by weight C5 monomers, at least 75% by weight C5 monomers, at least 85% by weight C5 monomers, at least 90% by weight C5 monomers, from 50% by weight C5 monomers to 100% by weight C5 monomers, from 75% by weight C5 monomers to 100 by weight C5 monomers, or even is derived entirely from C5 monomers. The non-hydrogenated high softening point C5 tackifying agent can be predominantly, or even entirely aliphatic.

The non-hydrogenated high softening point C5 tackifying agent can include a limited amount of aromatics. The non-hydrogenated high softening point C5 tackifying agent can have an aromatic content as tested by Nuclear Magnetic Resonance (NMR) of no greater than 25% by weight, no greater than 15%, or even from 3% by weight to 20% by weight.

The non-hydrogenated high softening point C5 tackifying agent has a Molten Gardner Color (50% resin solids in toluene) of no greater than 6, no greater than 5, no greater than 4, from 1 to 5, or even from 2 to 4.

The hot melt adhesive composition can contain more than one non-hydrogenated high softening point C5 tackifying agent.

The non-hydrogenated high softening point C5 tackifying agent can be present at from 5% by weight to 60% by weight, from 15% by weight to 55% by weight, from 20% by weight to 50% by weight, from 30% by weight to 48% by weight, or even from 35% by weight to 45% by weight.

Useful commercially available non-hydrogenated high softening point C5 tackifying agents include PICCOTAC 1115 available from Eastman Chemical Co.(Kingsport, Tenn.) and QUINTONE A100 and RX110 available from Zeon Europe GmbH (Dusseldorf, Germany).

Second Tackifying Agent

The hot melt adhesive composition can include a second tackifying agent different from the non-hydrogenated high softening point C5 tackifying agent

The second tackifying agent can be fluid or solid at room temperature. The second tackifying agent can be at least partially hydrogenated, to help lower the odor and color of the hot melt adhesive. Suitable classes of second tackifying agents include, e.g., aromatic, aliphatic (including lower softening point non-hydrogenated C5 tackifying agents) and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof. Examples of useful natural and modified rosins include gum rosin, wood rosin, tall oil rosin, distilled rosin, hydrogenated rosin, dimerized rosin and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, and phenolic-modified pentaerythritol esters of rosin.

The hot melt adhesive composition can include from 5% by weight to .40% by weight, from 5% by weight to 30% by weight, or even from 10% by weight to 40% by weight of the second tackifying agent.

Plasticizer

The hot melt adhesive composition can include a plasticizer. Suitable plasticizers include, e.g., naphthenic oils, paraffinic oils (e.g., cycloparaffin oils), mineral oils, phthalate esters, adipate esters, olefin oligomers (e.g., oligomers of polypropylene, polybutene, and hydrogenated polyisoprene), polybutenes, polyisoprene, hydrogenated polyisoprene, polybutadiene, benzoate esters, animal oil, plant oils (e.g. castor oil, soybean oil), derivatives of oils, glycerol esters of fatty acids, polyesters, polyethers, lactic acid derivatives and combinations thereof.

Useful commercially available plasticizers include CALSOL 5550 oil, a napthenic oil from Calumet Specialty Products Partners, LP (Indianapolis, Ind.), KAYDOL OIL, a mineral oil from Sonneborn (Tarrytown N.Y.) PARAPOL polybutene from Exxon Mobil Chemical Company (Houston, Tex.), OPPANOL polyisobutylene from BASF (Ludwigsjhafen, Germany), KRYSTOL 550 mineral oil from Petrochem Carless Limited (Surrey, England) and PURETOL 35 mineral oil from Petro Canada Lubricants Inc. (Mississauga, Ontario).

In one embodiment, the plasticizer is a naphthenic oil. The plasticizer can be present in the hot melt adhesive composition at from 0% by weight, to 40% by weight., from 5% by weight to 35% by weight, from 5% by weight to 20% by weight, from 10% by weight to 35% by weight, from 15% by weight to 30% by weight, or even from 20% by weight to 30% by weight.

Wax

The hot melt adhesive composition can be free of a wax, alternatively the hot melt adhesive composition can include a wax. Useful classes of wax include, e.g., paraffin waxes, microcrystalline waxes, high density low molecular weight polyethylene waxes, by-product polyethylene waxes, polypropylene waxes, Fischer-Tropsch waxes, oxidized Fischer-Tropsch waxes, functionalized waxes such as acid, anhydride, and hydroxyl modified waxes, animal waxes, vegetable waxes (e.g. soy wax) and combinations thereof. Useful waxes are solid at room temperature and preferably have a Ring and Ball softening point of from 50° C. to 170° C. The wax can be a propylene based wax with a Mettler Softening Point (ASTM D 6092) of greater than 130° C., greater than 140° C., or even greater than 150° C. Useful waxes are commercially available from a variety of suppliers including polypropylene and polyethylene waxes including the EPOLENE N and C series of trade designations from Westlake Chemical Corporation (Houston, Tex.) including e.g. EPOLENE N-21, EPOLENE N-1.5 and the LICOCENE series of trade designations, polypropylene and polyethylene waxes available from Clariant International Ltd. (Muttenz, Switzerland) including e.g. LICOCENE PP 6102, LICOCENE PP 6502 TP and LICOCENE PP 7502 TP.

The hot melt adhesive composition can include no greater than 10% by weight, no greater than 5% by weight, from 2% by weight to 10% by weight, or even from 3% to 8% by weight wax.

Additional Components

The hot melt adhesive composition optionally includes additional components including, e.g., stabilizers, antioxidants, additional polymers (e.g. styrenic block copolymers, ethylene based olefin polymers, butene based olefin polymers, etc.), adhesion promoters, coatings, anti-tack additives, ultraviolet light stabilizers, corrosion inhibitors, colorants (e.g., pigments and dyes), fillers, surfactants, wetness indicators, superabsorbents and combinations thereof.

Useful antioxidants include, e.g., pentaerythritol tetrakis[3,(3,5-di-tert-butyl-4-hydroxyphenyl)propionate], 2,2′-rnethylene bis(4-methyl-6-tent-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants and IRGAFOS 168 phosphite antioxidant, all of which are available from BASF Corporation (Florham Park, N.J.), and ETHYL 7 02 4,4′-methylene bis(2,6-di-tent-butylphenol). When present, the adhesive composition preferably includes from 0.1% by weight to 2% by weight antioxidant.

Disposable Absorbent Article

The hot melt adhesive can be incorporated in a variety of substrates within the disposable absorbent article including, e.g., films (e.g., polyolefin (e.g., polyethylene and polypropylene) films), release liners, porous substrates, cellulose substrates, sheets (e.g., paper, and fiber sheets), paper products, woven and nonwoven webs, fibers (e.g., synthetic polymer fibers and cellulose fibers), elastics and tape backings.

The hot melt adhesive composition is also useful in a variety of applications and constructions including, e.g., disposable absorbent articles including, e.g., disposable diapers, adult incontinence products, sanitary napkins, medical dressings (e.g., wound care products), bandages, surgical pads, pet training pads (e.g. puppy pads) and meat-packing products, and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue).

The hot melt adhesive composition is useful on substrates made from a variety of fibers including, e.g., natural cellulose fibers such as wood pulp, cotton, silk and wool; synthetic fibers such as nylon, rayon, polyesters, acrylics, polypropylenes, polyethylene, polyvinyl chloride, polyurethane, and glass; recycled fibers, and various combinations thereof.

Various application techniques can be used to apply the hot melt adhesive composition to a substrate including, e.g., slot coating, spraying including, e.g., spiral spraying and random spraying, screen printing, foaming, engraved roller, extrusion and meltblown application techniques.

Methods of Making a Disposable Absorbent Article

The hot melt adhesive composition can be used for construction applications. In a typical construction application in the manufacture of a disposable absorbent article, a body fluid impermeable backsheet is bonded to a nonwoven substrate. The adhesive may also be used to bond at least one additional layer or material selected from the group consisting of absorbents, tissues, elastomeric materials, superabsorbent polymers, and combinations thereof. For example, the adhesive can further be used for back sheet lamination i.e. where the body fluid impermeable backsheet typically a polyolefin film (e.g. polyethylene, polypropylene, ethylene vinyl acetate, ethylene copolymer, etc.) is bonded to a second nonwoven to improve the feel of the disposable article.

The invention will now be described by way of the following non-limiting examples. All parts, ratios, percents and amounts stated in the Examples are by weight unless otherwise specified.

### EXAMPLES

### Test Procedures

Test procedures used in the examples and throughout the specification, unless stated otherwise, include the following.

### Adhesive Sample Preparation

The hot melt adhesive samples were prepared in a sigma blade mixer with a batch size of 5000 grams. A heating oil temperature of around 177° C. was used. The polymer, tackifying agent and additives were added first, blended until smooth and then the plasticizer was added in portions. The mixture was allowed to mix until homogeneous and then dumped. Each sample took about 1 hour to make.

### Viscosity Test Method

Viscosity is determined in accordance with ASTM D-3236 entitled, “Standard Test Method for Apparent viscosity of Adhesives and Coating Materials,” (Oct. 31, 1988), using a Brookfield Thermosel viscometer Model RVDV 2 and a number 27 spindle. The results are reported in centipoise (cP).

### Mettler Dropping Point

ASTM D 6090, with a heating rate of 2° C./min.

### Peel Test Sample Preparation

A Summit spray applicator and laminator were set to an application temperature of 150° C., a nip pressure of 41.4 kilopascal (6 psi), an application weight as shown in the tables, and minimal rewind and unwind tensions so as not to stretch film. The continuous slot pattern is 1 inch (25.4 mm wide) wide. The back sheet was passed through the applicator and then the top sheet nonwoven was nipped into place.

The Top Sheet Nonwoven was UNIPRO 45 a nonwoven web from Midwest Filtration Company). The Back Sheet was Breathable film PW100429 BR149 16 GSM, 58.8 ″ wide 7500 WVTR Large OD) available from Clopay Plastic Products Company, Inc., (Cincinnati, Ohio).

The speed at which the film passes through the applicator is from 213.4 meters per minute (700 feet per minute (ft/min)) to 274.3 meters per minute (900 ft/min). A sufficient amount of laminate is prepared such that 152.4 centimeters (60 inches) of representative lamination can be collected for testing.

### Static Peel Test Method

From the laminations made in the sample preparation above, 4 inch wide (102 mm) test samples are cut. The samples are hung in an oven at 38C (100F) in a peel mode. 25 g of weight is placed on the sample. Samples are peeled in the cross-machine direction. The time to failure is measured in minutes. Six replicates are tested and the average time to fail is listed in the table.

### Dynamic Peel Test Method

The Dynamic Peel test is used to measure the bond strength of an adhesive coated between two flexible substrates. Dynamic Peel is determined using ASTM D1876-01 entitled, “Test Method for Determining Peel Resistance of Adhesive (T-Peel Test Method),” with the exception that it is run at 30.5 centimeters per minute (12 inches per minute), instead of 25.4 centimeters per minute (10 inches per minute), over a period of 10 seconds, and 7 replicates are run instead of the 10 specified in ASTM D1876. The samples are run on an INSTRON type test instrument. Unless otherwise specified, the test samples are prepared as described in the Sample Preparation test method. The samples are peeled in the machine direction. The average peel value over 10 seconds of peeling is recorded, and the results are reported in grams. The initial

Dynamic Peel value is the value measured 24 hours after the laminate is prepared.

TABLE 1

| | HAITACK | QUINTONE | QUINTONE | PICCOTAC |
|---|---|---|---|---|
| | JH-3200 | A100 | RX110 | 1115 |
| Ring and Ball | 89-96 | 100 | 110 | 110 |
| Softening Point | | | | |
| ASTM E-28 | | | | |
| (° C.) | | | | |
| Mettler | 91.7 | 99 | 109 | 116 |
| Dropping | | | | |
| Point (° C.) | | | | |
| Gardner Color | 3.3 | 4 | 2 | 3 |

TABLE 2

| | C1 | Ex 1 | Ex 2 | Ex3 |
|---|---|---|---|---|
| HAITACK JH-3200 | 39.4 | | | |
| QUINTONE A100 | | 39.4 | | |
| QUINTONE RX110 | | | 39.4 | |
| PICCOTAC 1115 | | | | 39.4 |
| Brookfield Viscosity @ 149° C. | 4075 | 4375 | 5012 | 4800 |
| (300° F.) - cP | | | | |
| Substrates: BS/TSNW | | | | |
| Static Peel (@39° C.) | 15.3 | 22.2 | 26.7 | 26.8 |
| (coat weight = 5 gsm) - minutes | | | | |
| Static Peel (@39° C.) | 17.3 | 28.7 | 32.2 | 30 |
| (coat weight = 6 gsm) - minutes | | | | |
| Dynamic Peel @ 23 C. (initial, | 495 | 504 | 552 | 517 |
| coat weight = 5 gsm) | | | | |
| Dynamic Peel @ 23 C. (2 wks | 567 | 593 | 612 | 577 |
| aged, coat weight = 5 gsm) | | | | |

Compositions C1, Ex 1, Ex 2 and Ex 3 are all the same composition with the exception of the tackifying agent which is as listed in Table 2. In addition to the tackifying agent all compositions include 29% by weight single-site catalyzed propylene-based polymer, 24% plasticizer, 5% wax and 2.4% additional components.

TABLE 3

| | Ex 4 | Ex 5 |
|---|---|---|
| LMODU S400 | | 10 |
| VISTAMAXX 8380 | 50 | 40 |
| PICCOTAC 1115 | 39.75 | 39.75 |
| CALSOL 5550 | 10 | 10 |
| BNX 1076 | 0.25 | 0.25 |
| Viscosity @ 149° C. | 3870 | 5125 |
| (300° F.) - cP | | |
| Substrates: BS/TSNW | | |
| Static Peel (@39° C.) (coat | 14.3 | 34 |
| weight = 5 gsm) - minutes | | |
| Dynamic Peel @ 23 C. | 243 | 272 |
| (initial, coat weight = 5 gsm) | | |
| Dynamic Peel @ 23 C. | Not tested | Not tested |
| (2 wks aged, coat weight = | | |
| 5 gsm) | | |

### Table 3—Substrates

The substrates were the same with the exception that the back sheet use was D11-284 PE MICROFLEX Embossed Non-Breathable film available from Clopay Plastic Products Company, Inc., (Cincinnati, Ohio))
Comment: In Table 2 (versus Table 3) a lower basis weight film (which is easier to bond to) was used as a back sheet. This gave the examples in Table 2 somewhat higher peel values (versus those in Table 3).

Other embodiments are within the claims.

What is claimed is

1. A hot melt adhesive composition comprising:
a.) a single-site catalyzed propylene-based polymer that has a co-monomer content of from 0% by weight to 20% by weight and a Brookfield Viscosity at 190° C. of no greater than 25,000; and
b.) a non-hydrogenated high softening point C5 tackifying agent having a softening point of from 98° C. to around 130° C.

2. The hot melt adhesive composition of claim 1 further comprising c.) From 5% to 35% by weight of a plasticizer.

3. The hot melt adhesive composition of claim 2 further comprising d.) a second tackifying agent.

4. The hot melt adhesive composition of claim 3 wherein the second tackifying agent is at least partially hydrogenated.

5. The hot melt adhesive of claim 1 wherein the non-hydrogenated high softening point C5 tackifying agent is derived from at least 50% by weight C5 monomers.

6. The hot melt adhesive of claim 1 wherein the non-hydrogenated high softening point C5 tackifying agent is derived from at least 75% by weight C5 monomers.

7. The hot melt adhesive composition of claim 1 comprising 15% by weight to 55% by weight of the non-hydrogenated high softening point C5 tackifying agent.

8. The hot melt adhesive composition of claim 1 comprising 15% by weight to 70% by weight of the single-site catalyzed propylene-based polymer.

9. The hot melt adhesive composition of claim 1 wherein the non-hydrogenated high softening point C5 tackifying agent has a Molten Gardner Color (50% by weight in toluene) of no greater than 6.

10. The hot melt adhesive composition claim 1 wherein the single-site catalyzed propylene-based polymer comprises a single-site catalyzed propylene-based homopolymer and a single-site catalyzed propylene-based copolymer.

11. The hot melt adhesive composition of claim 1 further comprising a wax.

12. The hot melt adhesive composition of claim 2 comprising 5% by weight to 20% by weight of a naphthenic oil plasticizer.

13. The hot melt adhesive composition of claim 2 comprising a naphthenic oil plasticizer and from 15% by weight to 55% by weight of the non-hydrogenated high softening point C5 tackifying agent.

14. The hot melt adhesive composition of claim 3, where the sum of a.), b.), and c.) and d.) makes up at least 90% of the composition.

15. The hot melt adhesive composition of claim 1 having a Brookfield Viscosity at 150° C. of no greater than 16,000 cP.

16. A disposable absorbent article comprising:
a.) a body fluid impermeable back sheet,
b.) a nonwoven top sheet, and
c.) a hot melt adhesive composition comprising:
i. a single-site catalyzed propylene-based polymer that has a co-monomer content of from 0% by weight to 20% by weight and a Brookfield Viscosity at 190° C. of no greater than 25,000; and
ii. a non-hydrogenated high softening point C5 tackifying agent having a softening point of from 98° C. to around 130° C.
wherein the body fluid impermeable back sheet is adhered to the nonwoven top sheet through the hot melt adhesive composition.

17. The disposable absorbent article of claim 16 wherein the hot melt adhesive composition comprises from 15% by weight to 55% by weight of the non-hydrogenated high softening point C5 tackifying agent.

18. The disposable absorbent article of claim 16 wherein the single-site catalyzed propylene-based polymer comprises a single-site catalyzed propylene-based homopolymer and a single-site catalyzed propylene-based copolymer.
